(19) United States
(12) Patent Application Publication
(10) Pub. No.: US 2015/0013425 A1
(43) Pub. Date: Jan. 15, 2015

(54) Internal Mechanical Stress Improvement Method for Mitigating Stress Corrosion Cracking in Weld Areas of Nuclear Power Plant Piping

(71) Applicants: James E. Nestell, Alexandria, VA (US); David W. Rackiewicz, Alexandria, VA (US); Alan C. Kepple, Alexandria, VA (US)

(72) Inventors: James E. Nestell, Alexandria, VA (US); David W. Rackiewicz, Alexandria, VA (US); Alan C. Kepple, Alexandria, VA (US)

(21) Appl. No.: 13/942,608

(22) Filed: Jul. 15, 2013

(51) Int. Cl. G21C 17/017

(52) U.S. Cl. CPC G21C 17/017
USPC 72/370.01

(57) ABSTRACT

Method for mitigating stress corrosion cracking at an internal (i.e., wetted-side) weld area in piping of a nuclear power plant includes the steps of actuating a radially movable tool to produce a radial load against the internal (i.e., normally wetted) surfaces at or near the weld area to create a deep residual compressive stress state at the wetted surface of the weld. The method permits post-process verification by physical measurements of surface distortion.

### CROSS-REFERENCE TO RELATED PATENT APPLICATION

This application claims priority from U.S. provisional patent application Ser. No. 61/671,428 filed Jul. 13, 2012, the entire disclosure of which is incorporated herein by reference.

### BACKGROUND OF THE INVENTION

1. Field of the Invention

The present invention pertains to internal mechanical stress improvement for mitigating stress corrosion cracking in weld areas of piping, in particular, nozzles, safe ends (nozzle extension pieces) and pipes used in nuclear power plants.

2. Brief Discussion of the Related Art

Stress corrosion cracking and failure of nickel alloy pressure boundaries have been observed in nuclear reactor plant component applications since the 1980 s. Most of the failures have been observed in wrought nickel alloy materials with less than 20% chromium, like NiCrFe Alloy 600, used in components exposed to reactor coolant environments, at high temperatures (typically greater than 600° F.), and at high stresses (typically greater than 80% of yield strength). Cracking has also been observed in weld areas using nickel alloy weld material, such as Alloy 82 and Alloy 182, which are widely used in the nuclear industry for joining dissimilar metals, such as stainless steel to low-alloy steel reactor plant nozzle-to-piping welds.

As a result of weld cracking, the nuclear industry must perform more frequent in-service weld inspections. Nuclear plants that have not mitigated such weld areas must perform ultrasonic inspections in reactor vessel nozzles every five years, and this incurs a very high cost per inspection. An ultrasonic inspection often requires an extra core barrel removal operation and a three- day outage extension. In addition to inspection requirement, plants with unmitigated welds are exposed to the risk associated with stress corrosion cracking developing in the weld areas.

To mitigate potential for cracking and to obtain relief from frequency of inspections, there is a need in the nuclear industry for economical mitigation of Alloy 82/182 welds in reactor vessel piping. As used herein, “piping” means all fluid conduits in nuclear power plants including, but not limited to, pipes, nozzles and safe ends.

The initiation of cracking can be mitigated and the growth of preexisting small cracks can be arrested by creating a deep compressive stress field on the internal or wetted surface of the Alloy 82/182 weld area. This can be done by imposing a carefully engineered large deformation layer (i.e., beyond yield strength or greater than 0.2% strain) on the piping at the weld area.

Some methods have been developed and applied that can mitigate the cracking susceptibility of the internal weld surface by techniques applied to the outside (i.e., dry) surface of the piping. However, access to the outer surfaces is not always practicable in nuclear power plant piping. Examples of this include, but are not limited to, designs for which the locations of the welds occur within radiation shields typically formed of reinforced concrete of substantial thickness (typically five feet), or occur in areas to which external access is restricted by equipment or by high radiation levels, or are entirely inside the reactor vessel (such as instrumentation penetrations).

In plants that do not have access to the outside (i.e., dry) surface of the piping weld areas, economical mitigation of such weld areas is particularly challenging. In the past, attempts to internally (i.e., from the wetted side) mitigate cracking in Alloy 82/182 weld areas have included performing internal weld on-lay and internal surface peening. The weld on-lay process is prohibitively expensive and risks significant delays if a problem occurs in accepting the final weld condition. Internal surface peening methods, such as water jet peening, laser peening and laser shock peening, have the disadvantage of creating only a very shallow compressive stress field (less than 1 mm or 0.04 inches deep) on the peened surface, cannot be confirmed by post-process measurements and cannot stop pre-existing small cracks which are deeper than the shallow peened metal layer. Neither of these methods is currently relied on for mitigation in the U.S. and neither method has an identified path to relief of weld inspection frequency requirements:

### SUMMARY OF THE INVENTION

The present invention relates to internal methods and apparatus for mitigating crack growth in weld areas in piping by the direct application of large radial forces to the internal (i.e., wetted) surface of the weld areas of the piping, thereby creating a deep residual compressive stress state on the target weld area. This internal mechanical stress improvement method permits mitigation of welds solely by forces applied directly to the normally wetted surfaces (e.g., by access via the inside of a reactor vessel) of piping, as compared with the prior art external (i.e., dry surface) mechanical methods.

In accordance with the present invention, flaw or crack growth in a piping weld area is arrested by creating a deep compressive stress field on the inside (i.e., wetted) surface of the weld area, such as Alloy 82/182 weld areas in nuclear power plant nozzles and piping. Methods according to the present invention create compressive stress fields on the wetted surface of the weld areas to be mitigated by imposing a large deformation using radial force applied to the wetted surface of the piping by an operating end of a tool located at the area of the weld.

A primary aspect of the present invention is to mitigate cracking in weld areas in piping of nuclear power plants by applying radial forces to the internal surface of the weld area to create deep residual compressive stress at the weld area. Various tools and apparatus can be utilized to create the large radial forces including wedge, roller and pneumatic arrangements through mechanical, hydraulic and/or pneumatic devices.

Some of the advantages of the present invention over the prior art are that stress mitigation can be achieved by applying radial forces internally of piping at a weld area thereby overcoming the issues associated with weld areas that are not externally accessible.

Other aspects and advantages of the present invention will become apparent from the following description of the preferred embodiments taken in conjunction with the accompanying drawings wherein like parts in each of the several figures are identified by the same reference characters.

### BRIEF DESCRIPTION OF THE DRAWINGS

FIG. 1 is a broken view of a portion of a nuclear power plant having an externally obstructed reactor vessel nozzle.

FIG. 2 is a broken axial cross-section of piping with a circumferential weld area commonly used in nuclear plants with the weld area in its original configuration.

FIG. 3 is a broken axial cross-section of the piping shown in FIG. 2 subjected to radial force displacement at the weld or target area in accordance with the present invention.

FIG. 4 is a broken axial cross-section of the piping shown in FIG. 3 after removal of the radial force showing the compressive state created.

FIGS. 5 and 6 are broken front and side views, respectively, of a hydraulic/mechanical expansion device carried on an operating end of an elongate tool for use in the method of the present invention.

FIG. 7 is a broken section of a pneumatic expansion device carried on the operating end of an elongate tool for use in the method of the present invention.

### DESCRIPTION OF THE INVENTION

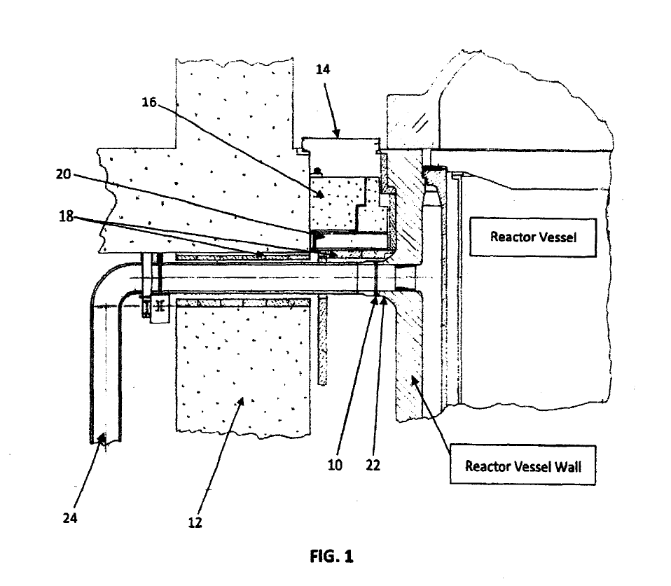

There are many reasons why an internally applied stress mitigation device is preferred to an externally applied device, such as inaccessibility, physical interferences or impractical environment. One example is a nuclear power plant having an externally obstructed reactor vessel nozzle configuration as shown in FIG. 1 with weld areas 10 to be mitigated in accordance with the present invention being surrounded by concrete shields, only the primary shield 12 of which is denoted. The remaining components of the nuclear power plant that would have to be removed to gain outside access to the nozzle weld areas 10 are shown at refueling cavity seal plate 14, shield plugs 16, insulation 18 and structural steel 20, all of which are located adjacent the reactor vessel and the reactor vessel wall. A nozzle 22 is located at a free end of a length of stainless steel piping 24 which has an L-configuration as shown.

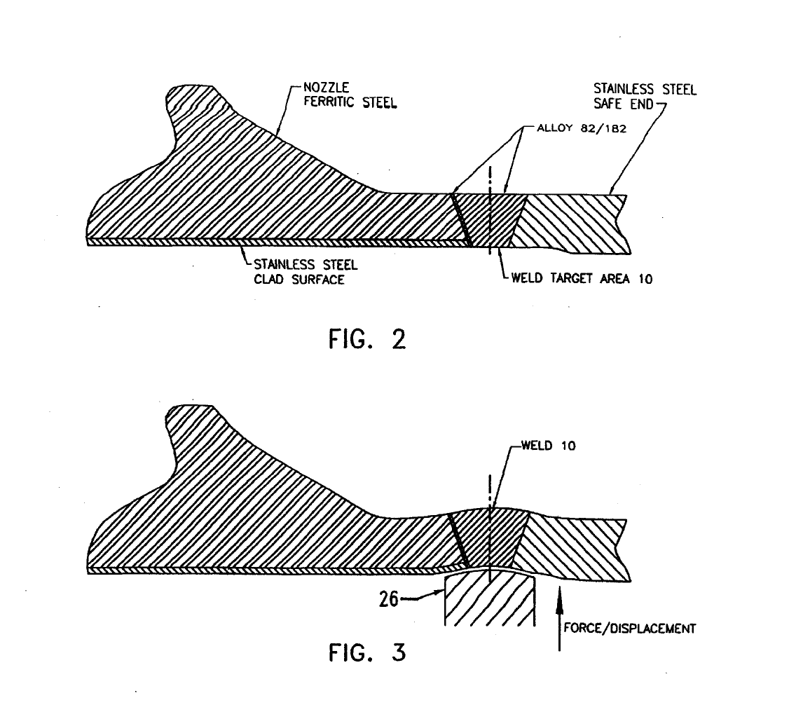

Weld areas are illustrated in FIG. 2 wherein it can be seen that weld Alloy 82/182 is situated between the stainless steel safe end and the nozzle ferritic steel. Accordingly, the location of the weld area labeled “target area” can be seen to be not easily accessible when referencing FIG. 1. The Alloy 82/182 weld area, as noted above, can experience crack growth at the wetted surface which needs to be mitigated.

In accordance with the present invention, as shown in FIG. 3, the weld area 10 experiences the direct application of large radial forces on the internal surface of the piping to create a deep residual compressive stress state on the inside diameter thereof. As shown in FIG. 3, the radial force is applied via a member 26, such as a forming die, carried on an operating end of an elongate tool inserted in the piping which results in a displacement of the inner surface beyond the plastic strain limit.

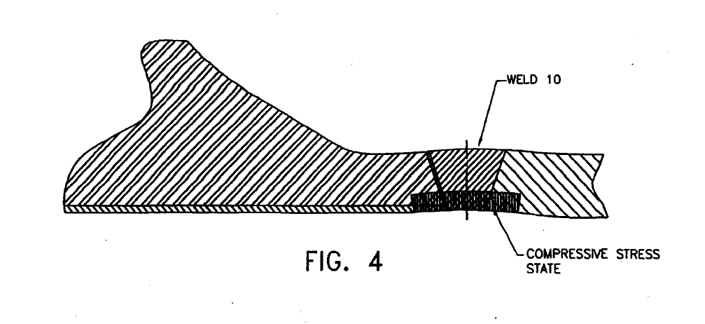

FIG. 4 illustrates the final configuration of the target weld area 10 in a compressive stress state after removal of the member 26 shown in FIG. 3. As shown in FIG. 4, the weld area has a deep residual compressive stress state after being subjected to the radial force/displacement and a measurable residual plastic displacement that can be measured to verify successful mitigation.

In accordance with the present invention, large radial loads are directly applied to the weld area on the internal (wetted) surface of the piping (e.g. nozzle or safe end) by a radially movable member 26 to create, after removal of the member, a deep residual compressive stress state on the wetted surface of the weld area to mitigate stress corrosion cracking of the weld.

The shape and axial location of the member 26 that is used to plastically deform the wetted weld area is important for developing the optimum residual stress field at the wetted weld surface. For a pipe-to-nozzle butt weld, while the form of the member shown in FIG. 3 will give adequate compressive residual stress in the circumferential (hoop) direction, a different shape of the member can be used to provide stress improvement in the axial direction. In the case of a J-groove weld, such as found in pressure vessel standpipes, the wetted area of the weld forms a fillet between the vessel and the outer diameter of the standpipe of the nozzle. In this case, the axial locations requiring loading by the member 26 are different than for the butt weld. Engineering analyses are necessary to find the optimal deformations needed to produce the most improved residual stress condition.

Various tools can be utilized to provide application of sufficient radial force around the circumference of the piping at the weld area to cause the inside fibers of the piping (e.g. nozzle, safe end) to yield plastically. After the force is released, a compressive axial and circumferential residual stress field is created on the internal (i.e., wetted) surface of the weld area as shown in FIG. 4. The depth of the compressive stress field through the piping/weld area wall thickness can be controlled by the amount of expansion developed during the radial displacement shown in FIG. 3.

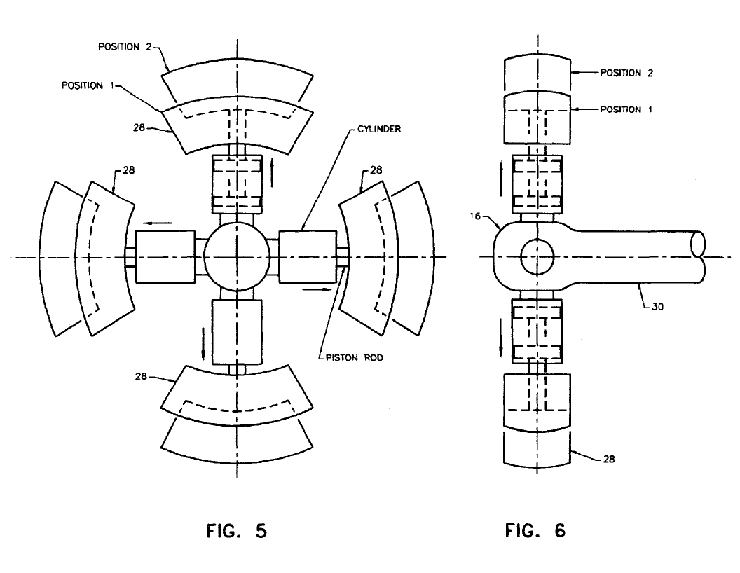

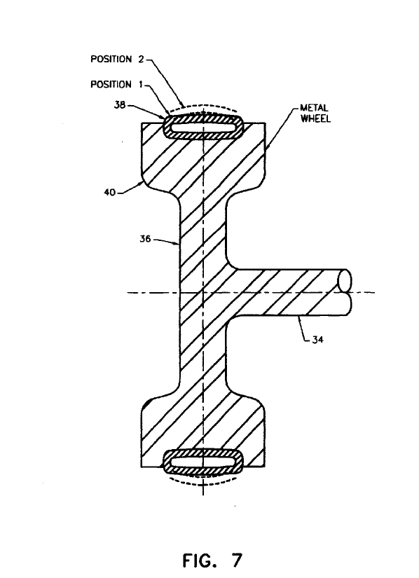

Some examples of tools/devices that can be utilized with the method of the present invention are shown in FIGS. 5 and 6 and 7. The tool shown in FIGS. 5 and 6 expands the target weld area with a radially movable member in the form of wedges 28 driven radially outward by mechanical or hydraulic forces with appropriate mechanisms. As shown in FIGS. 5 and 6, the wedges 28 are carried by a shaft 30 at an operating end 32 of the tool to have withdrawn positions shown as position 1 in FIGS. 5 and 6 to allow insertion and placement in the piping adjacent the target weld area. Once properly positioned, the operating end of the tool is actuated to move the wedges radially to position 2 shown in FIGS. 5 and 6 such that the curved outer edges of the wedges form the member 26 shown in FIG. 3 that contacts the inner surface to produce the radial force against the weld area. The method may require more than one application of radial force expansion with different angular orientations of the wedges to cover gaps in the member face when the wedges are in the expanded position 2 or to otherwise ensure the desired expansion coverage around the target weld area circumference. As another variation, the wedges can push out in steps against a set of rollers whose contour in contact with the inner wall will produce the form of the member 26 shown in FIG. 3 on the end of each expanding leg and the shaft 30 can be rotated so that the rollers form the residual stress condition shown in FIG. 4.

Another example of a tool for use in radial expansion of weld areas in accordance with the present invention is shown in FIG. 7 wherein a shaft 34 has an operating end 36 carrying a toroidal inflatable bladder 38, essentially a reinforced tire, affixed to a disk 40. To provide accessibility through narrower diametral interferences in the pipe/nozzle inner diameter, the operating end may be expanded or contracted in diameter, by means not illustrated, to the radial position shown in FIG. 7. Pressurization of the bladder through passages not illustrated causes the outer surface of the bladder to expand from Position 1 to Position 2 such that the outer surface of the bladder forms the member 26 shown in FIG. 3 creating radial forces at the weld area to create the stress on the weld area. Once the pressure in the bladder is released, a compressive residual stress field is produced on the inside (wetted) surface of the target weld area.

As will be appreciated, the tools shown in FIGS. 5, 6 and 7 will be attached to a long shaft that can be lowered into the reactor vessel during an outage such that the operating end can be positioned adjacent the weld area. Mechanical positioning methods, hydraulic and/or pneumatic lines with fluidic passages and control systems can be available through the shaft.

Inasmuch as the present invention is subject to many variations. modifications and changes in detail, it is intended that all subject matter discussed above or shown in the accompanying drawings be interpreted as illustrative only and not be taken in a limiting sense.

What is claimed is:

1. An internal, wetted side, mechanical method for mitigating stress corrosion cracking at an internal weld area in piping in a nuclear power plant comprising the steps of
inserting a tool internally to the piping, the tool having an operating end with a radially movable member;
positioning the operating end adjacent the weld area;
actuating the operating end to move the radially movable member to contact and produce a radial load on the internal surface of the piping near the weld area; and
removing the tool to create, when the tool is removed, a deep residual compressive stress state at the weld area.

2. The method for mitigating stress corrosion cracking at an internal weld area as recited in claim 1 wherein said actuating step includes mechanically moving a plurality of wedges radially outwardly.

3. The method for mitigating stress corrosion cracking at an internal weld area as recited in claim 1 wherein said actuating step includes supplying fluid to a bladder to radially expand the bladder.

4. The method for mitigating stress corrosion cracking at an internal weld area as recited in claim 1 wherein the radially movable member exerts the radially outward displacement of the pipe at one or more axial locations adjacent the weld area to create a desired magnitude, depth and orientation of the residual compressive stress field.

5. The method for mitigating stress corrosion cracking at an internal weld area as recited in claim 1 wherein the weld area is on the inner diameter of a nozzle, safe end or pipe.
